(19) United States
(12) Patent Application Publication
(10) Pub. No.: US 2024/0311121 A1
(43) Pub. Date: Sep. 19, 2024

(54) SYSTEM AND METHOD FOR EFFICIENT UPDATES OF MULTIPLE DEVICES

(71) Applicant: TOSHIBA TEC KABUSHIKI KAISHA, Tokyo (JP)

(72) Inventor: Louis M. Ormond, Irvine, CA (US)

(21) Appl. No.: 18/122,562

(22) Filed: Mar. 16, 2023

(51) Int. Cl. G06F 8/65; G06F 9/445; H04L 41/12; H04L 67/00

(52) U.S. Cl. CPC G06F 8/65; G06F 9/44505; H04L 41/12; H04L 67/34

(57) ABSTRACT

A system and method for efficient updating or configuration of a fleet of multifunction peripherals includes grouping of devices associated with a customer. Address information for the customer's network is parsed. Devices are designated a primary devices or secondary devices based on an assigned weighting determined by network topology and historical update records. Primary devices are provided with an instruction to download and install an update package of software or configurations from a designated server. After a successful installation, primary devices make the package available to secondary devices. Secondary devices are provides with an instruction to download and install the package obtained from a primary device. An alternative primary device is provided if an update on a secondary device is unsuccessful.

### TECHNICAL FIELD OF THE INVENTION

This application relates generally to maintenance of a fleet of multifunction peripherals. The application relates particularly to distribution of software or configuration updates with the assistance of multifunction peripherals determined to be primary devices on a customer network.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Businesses often have a fleet of MFPs which is maintained internally or via an agreement with a servicing company, such as an MFP device distributor. MFP maintenance entails installation of new software, which may comprise new firmware. MFP maintenance may also include device configuration or reconfiguration.

### BRIEF DESCRIPTION OF THE DRAWINGS

Various embodiments will become better understood with regard to the following description, appended claims and accompanying drawings wherein:

FIG. 1 is an example embodiment of a system for efficient updates of multiple multifunction peripherals;

FIG. 2 is an example embodiment of a networked digital device, such as multifunction peripheral;

FIG. 3 is an example embodiment of a digital device system;

FIG. 4 is a block diagram of an example embodiment of a system for efficient updates of multiple multifunction peripherals; and

FIG. 5 is a flow diagram of an example embodiment of a system for efficient updates of multiple multifunction peripherals.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFP fleet maintenance may be accomplished by network distribution of software or device configurations. It is very time consuming to maintain devices by servicing individual machines.

MFP maintenance, such as that noted above, can be assisted by network device monitoring and configuring. An example is provided with Toshiba TEC's e-Bridge Cloud Connect system (eCC). ECC is implemented as a web-based device management system that facilitates real-time monitoring of technical alerts and warnings, remote device configuration and software changes, and accumulation of service data for problem diagnosis and problem resolution.

By way of particular example, Toshiba TEC MFP devices are configurable via an eCC web interface. Device configuration with eCC can be completed by setting device policies. Policies are used to create a near infinite number of attributes to monitor and configure a MFP or fleet of MFPs. Policies are organized into categories, and templates are provided to make the configuration of a policy fairly intuitive. Policy categories for eCC include settings for:
Firmware Update
Device Error Processing
Backup
Device Communication
Custom Settings
Additional policy categories

Systems such as eCC allow one to manually configure a policy to pull a firmware package from a local shared storage. However, it is manual, requiring a service technician to coordinate with a customer to store the firmware package and then configure a policy properly with information about the local storage.

Example policy updates may include code value pairs for machine configurations and firmware. In the case of firmware, packages being downloaded are large, often exceeding 1 GB is size. Downloads of this size place a burden on the customer's local network bandwidth, are slow to download, and many times result in update failure. This burden and failure condition is exacerbated in cases where a single customer has multiple devices being updated. Each machine is individually trying to download the firmware file, competing for bandwidth with all the other machines and resources on the network.

In example embodiments described herein, machines within the same customer network environment and providing an automated and dynamic update instruction to reduce Internet bandwidth usage. This is accomplished by systematically grouping machines by customer, parsing IP addresses information, and assigning scores to devices to determine order and roles of machines being updated. Update instruction packages are automatically configured to allow the high scoring machines, designated as primary machines, a first attempt at downloading updates. These machines will update package downloads first, and if successful, make the update available to the secondary devices. The primary machines report back to a cloud-based server of a download status. The server then automatically reconfigures update instructions for the other machines to signal an update is available and point to a machine that has already downloaded the update. Remaining machines on the same customer network will attempt to pull the update from a shared storage location on the primary device. Status of updates is be communicated back to the cloud server. If failures occur, the cloud server will automatically update the instructions by assigning a new primary device and reinitiating the process.

Data hosted in a cloud service is used to group machines based on customer information, such as a customer account number. The system checks IP address information of the grouped machines to create a network topology for the customer for analysis. The system further analyzes historical device update records. Using this data, the cloud server will assign scores to determine primary and secondary roles to each of the devices in the group.

When a new policy is applied to devices within a customer group, the cloud server uses primary and secondary role information to configure instruction packages to minimize download bandwidth usage. Machines in the field are given update instructions that will minimize download bandwidth usage while maintaining or increasing update success rates. These instructions inform connecting devices the order for downloading updates, the download location, the timing of downloads, and other data. Error conditions and networking failures are detected and handled. Thus, if an initial primary device update fails, additional attempts will be made and also failover to designate a new primary device. Similarly, if a primary device update fails a new server can be designated to retrieve the update.

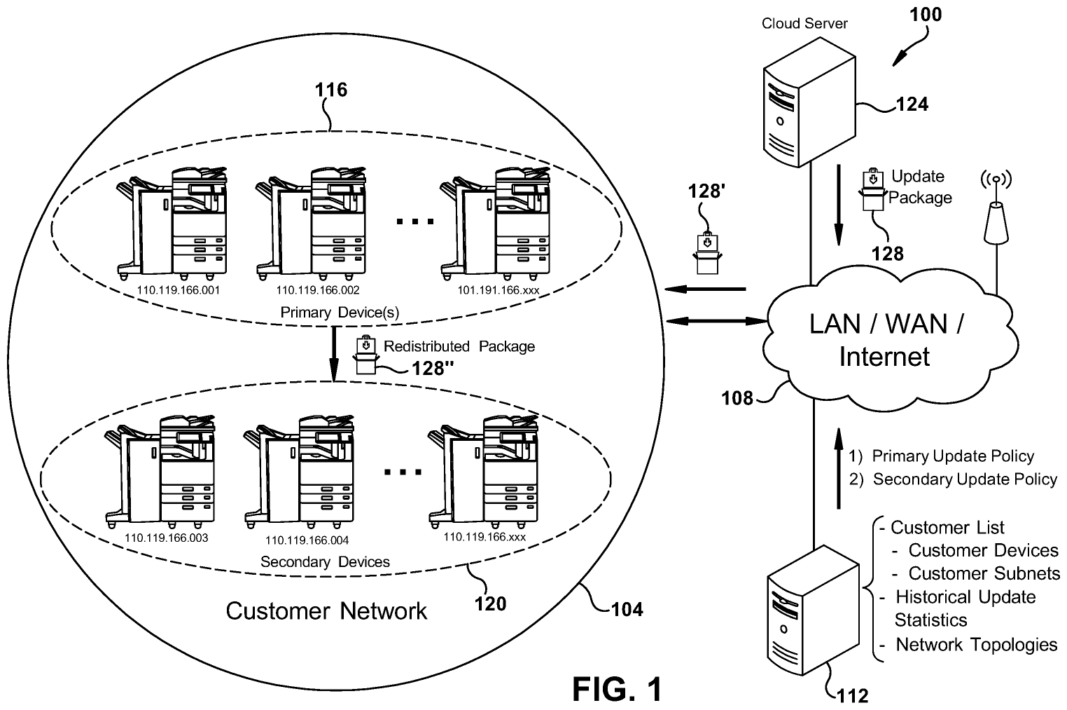

FIG. 1 illustrates an example embodiment of a system 100 for efficient updates of multiple MFPs. A customer network 104 includes a fleet of MFPs residing in customer network 104. Included in FIG. 1 is network cloud 108, suitably comprised of a local area network (LAN), a wide area network (WAN), which may comprise the Internet, or any suitable combination thereof. Network cloud 108 is comprised of any suitable wireless or wired data connection or combination thereof, and facilitates data communication among and between the illustrated devices. Server 112 suitably serves as a print management server, such as a server running Toshiba TEC's eCC. Server 112 includes information for one or more customers for whom MFP maintenance is performed. Such information may include a listing of customer devices and information about their networks, such as IP address ranges, subnets, or the like. Server 112 also stores historical update statistics associated with updates, modifications or reconfigurations previously completed for customers.

When an update or configuration is desired, server 112 examines the network of the associated customer. In the illustrated example, server 112 analyzes IP addresses in customer network 104, suitably by parsing, in conjunction with stored information which provides an understanding of a topology of customer network 104 and its associated devices. From such information, server 112 assigns a score to each device. One or more high scoring devices are designated as primary devices. Lower scoring devices are designate as secondary devices. In the illustrated example, MFPs 116 are designated as primary devices and MFPs 120 are designated as secondary devices.

Server 112 then prepares two update policies, one for primary devices and one for secondary devices. The policies direct devices to commence a designated update operation. The policies are distributed to correspondingly designated devices via network cloud 108. Upon receiving their update policy, primary devices 116 are directed to download and install an update packet, suitably retrieved from cloud server 124. In the illustrated example primary devices download update package 128 and install it, suitably reporting successful or unsuccessful installation back to cloud server 124. If an installation is unsuccessful, cloud server can resend a packet or direct a packet from an alternative server. While two servers, server 112 and cloud sever 124 are used in the illustrated example, it is to be appreciated that all operations may be consolidated in a single server, or deployed on additional servers. As detailed further below, MFPs themselves are intelligent devices that can also function as a server.

Once an update package has been successfully obtained and installed by primary devices, it is made available to secondary devices, such as secondary devices 120 of customer network 104. Secondary devices 120 are directed by their update policy to retrieve their update packet 128″ from a device designated as primary, as with primary devices 116. As with primary devices, secondary devices install the update packet and report a successful or unsuccessful installation. Unsuccessful installations are suitably provided with a new update packet which may come from the same primary device, an alternative primary device or directly from cloud server 124.

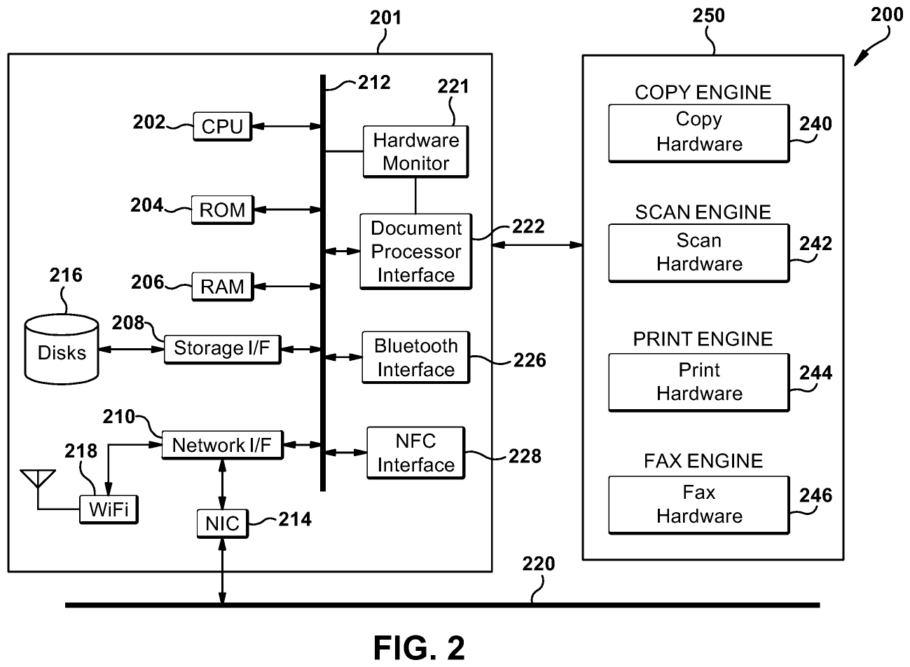

Turning now to FIG. 2, illustrated is an example embodiment of a networked digital device comprised of document rendering system 200 suitably comprised within an MFP, such as with MFPs of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with input/output interface 222, suitably comprising a user touchscreen. While touchscreens are discussed in example embodiments herein, it is to be appreciated that any suitable user interface, such as keyboards, switches, displays, trackballs or mice may be used.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with additional interfaces, such as Bluetooth interface 226 and NFC interface 228.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) network interface 222 which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 250, including MFP functional units. In the illustrated example, these units include a copy engine comprising copy hardware 240, a scan engine comprise of scan hardware 242, a print engine comprised of print hardware 244 and a fax engine comprised of fax hardware 246 which together comprise document rendering system 250. It will be understood that functional units are suitably comprised of intelligent units, including any suitable hardware or software platform.

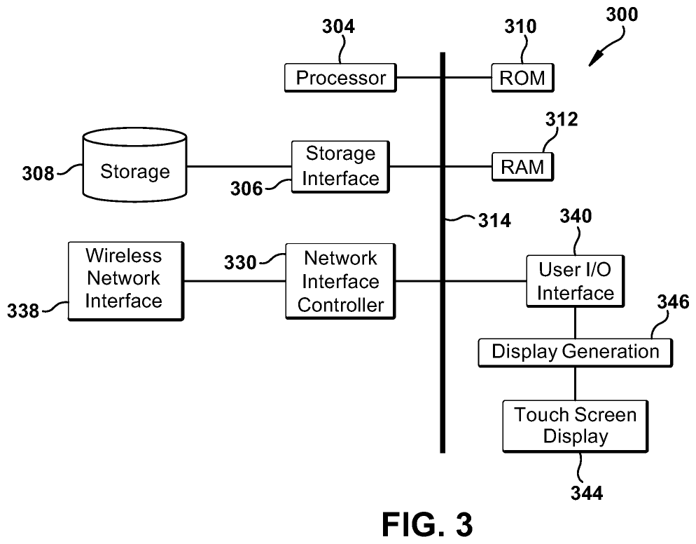

Turning now to FIG. 3, illustrated is an example embodiment of a digital data processing device 300 such as server 112 and cloud server 124 of FIG. 1. It is to be appreciated that some components listed may be unnecessary in certain configurations. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Data communication among components is accomplished via data bus 314. A network interface controller 330 suitably provides a gateway for data communication with other devices, via any wireless or wired connection, such as via wireless network interface 338. A user input/output interface 340 is suitably comprised of display generator 346 interfacing with touchscreen display 344. As noted above, any suitable user input and display can be used. Digital camera 352 is also suitably used for facial recognition, including facial recognition for securing device access.

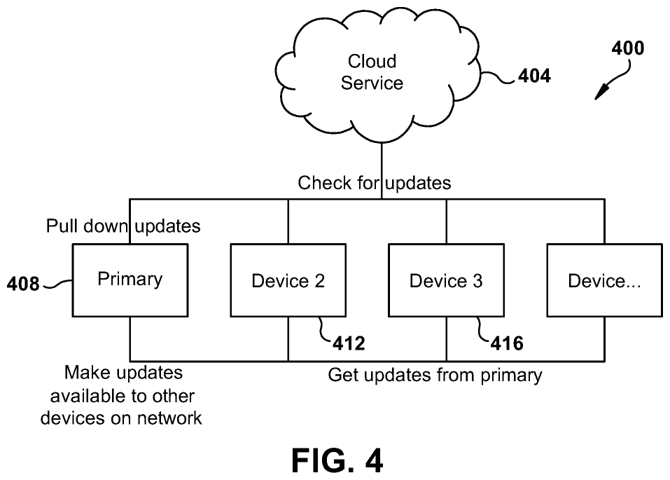

FIG. 4 is a block diagram 400 of an example embodiment of a system for efficient updates of multiple MFPs. Cloud service 404 is in data communication with a primary device 408 and one or more secondary devices, such as device 2 and device 3. Primary device 408 checks for updates from cloud service 404, and downloads them when available, storing a copy locally. The local copy is made available to secondary devices 412 and 416. These devices retrieve the update from primary device 408 and it is installed.

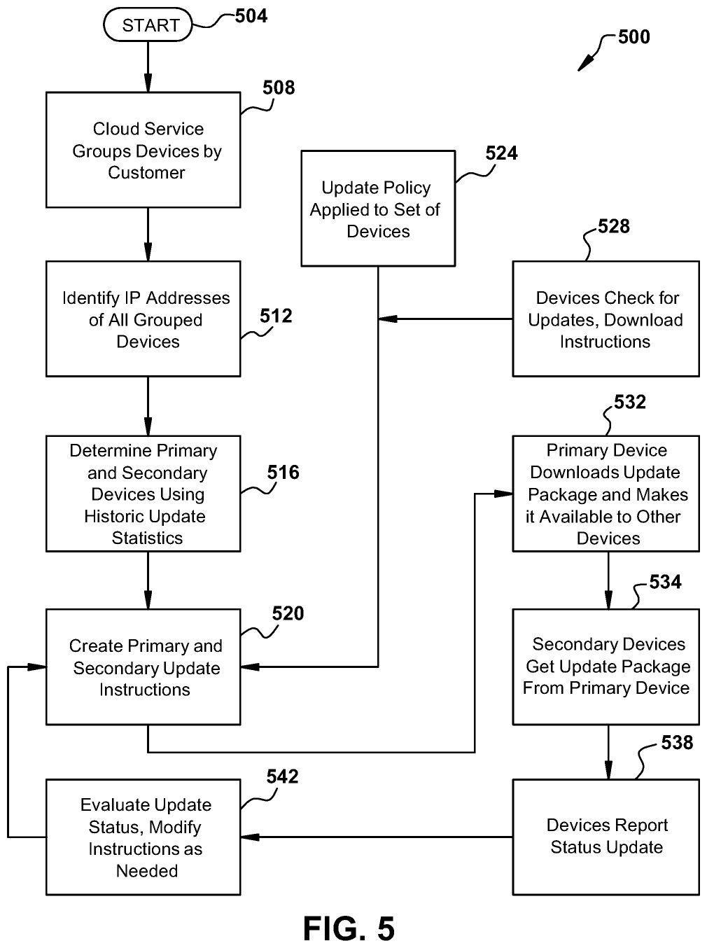

FIG. 5 is a flow diagram 500 of an example embodiment of a system for efficient updates of multiple MFPs. The system commences at block 504 and proceeds to block 508 where a cloud service groups devices by customer. Network addresses, such as IP addresses, for grouped devices are identified at block 512. Primary and secondary devices are determined using historic update statistics at block 516. Such statistics may include for devices such as frequency of updates, number of prior updates, update success rates, system responsiveness, device model number, device firmware, device firmware version, installed software, installed device options, network proximity, and the like.

Update instructions are created at block 520, with a primary update instruction for designated primary devices and with a secondary update instruction for designated secondary devices. An update policy is applied to a set of devices at block 524. Devices check for updates and download instructions at block 528. Primary device(s) download update packages and make them available to other devices at block 532. Secondary devices then get the update package from a primary device at block 534. Devices issue a status report, such as successful or unsuccessful package installation, at block 538. Instructions are evaluated and modified, if needed, at block 542. Modified instructions are communicated to block 520 for use in a subsequent update process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor;
memory;
a network interface configured to receive data identifying a device group corresponding to a plurality of networked multifunction peripherals associated with a customer;
the memory storing historical update statistics corresponding prior updates made to the plurality of networked multifunction peripherals;
the processor configured determine addresses of each of the plurality of networked multifunction peripherals;
the processor configured to determine a network topology for each of the plurality of networked multifunction peripherals in accordance with determined addresses;
the processor further configured to assign a score to each of the plurality of networked multifunction peripherals in accordance with the historical update statistics and the network topology;
the processor further configured to assign one of a primary role and a secondary role to each of the plurality of networked multifunction peripherals in accordance with its assigned score; and
the processor further configured to initiate a transfer of an update instruction package containing instructions to download and install an update package to each of the plurality of networked multifunction peripherals with an assigned primary role.

2. The system of claim 1 wherein each of the plurality of networked multifunction peripherals assigned a primary role is configured to:
download an update package responsive to a received update instruction package;
install the downloaded update package;
report installation of the downloaded update package to an associated cloud server;
receive an update package request from one or more of the plurality of networked multifunction peripherals with an assigned secondary role; and
send a copy of the downloaded update package to each of the plurality of networked multifunction peripherals with the assigned secondary role responsive to each received update package request.

3. The system of claim 2 wherein each of the plurality of networked multifunction peripherals with the assigned secondary role is configured to:
receive an update instruction from the associated cloud server;
request an update package from a primary role multifunction peripheral designated by the update instruction received from the associated cloud server;
receive the update package from the designated primary role multifunction peripheral;
commence an installation of the received update package; and
report whether a commenced installation was successfully completed to the associated cloud server.

4. The system of claim 3 wherein each of the plurality of networked multifunction peripherals with the assigned secondary role is further configured to:
receive a new update instruction from the cloud server responsive to a report that the installation was unsuccessful;
request an update package from a secondary designated primary role multifunction peripheral in accordance with the new update instruction;
receive a secondary update package from the secondary designated primary role multifunction peripheral responsive to the request; and
install the secondary update package.

5. The system of claim 4 wherein the update package is comprised of a device policy to download and update.

6. The system of claim 5 wherein the device policy comprises a firmware update instruction.

7. The system of claim 5 wherein the device policy comprises a device configuration.

8. A method comprising:
receiving, via a network interface, data identifying a device group corresponding to a plurality of networked multifunction peripherals associated with a customer;
storing, in a memory, historical update statistics corresponding prior updates made to the plurality of networked multifunction peripherals;
determining addresses of each of the plurality of networked multifunction peripherals;
determining a network topology for the plurality of networked multifunction peripherals in accordance with determined addresses;
assigning a score to each of the plurality of networked multifunction peripherals in accordance with the historical update statistics and the network topology;
assigning one of a primary role and a secondary role to each of the plurality of networked multifunction peripherals in accordance with its assigned score; and
initiating a transfer of an update instruction package containing instructions to download and install an update package to each of the plurality of networked multifunction peripherals with an assigned primary role.

9. The method of claim 8 further comprising, for each of the plurality of networked multifunction peripherals assigned a primary role:
downloading an update package responsive to a received update instruction package;
installing the downloaded update package;
reporting installation of the downloaded update package to an associated cloud server;
receiving an update package request from one or more of the plurality of networked multifunction peripherals with an assigned secondary role; and
sending a copy of the downloaded update package to each of the plurality of networked multifunction peripherals with the assigned secondary role responsive to each received update package request.

10. The method of claim 9 further comprising, for each of the plurality of networked multifunction peripherals with the assigned secondary role:
receiving an update instruction from the associated cloud server;
requesting an update package from a primary role multifunction peripheral designated by the update instruction received from the associated cloud server,
receiving the update package from the designated primary role multifunction peripheral;
commencing an installation of the received update package; and
reporting whether a commenced installation was successfully completed to the associated cloud server.

11. The method of claim 10 further comprising, for each of the plurality of networked multifunction peripherals with the assigned secondary role:
receiving a new update instruction from the associated cloud server responsive to a report that the installation was unsuccessful;
requesting an update package from a secondary designated primary role multifunction peripheral in accordance with the new update instruction;
receiving a secondary update package from the secondary designated primary role multifunction peripheral responsive to the request; and
installing the secondary update package.

12. The method of claim 11 wherein the update package is comprised of a device policy to download and update.

13. The method of claim 12 wherein the device policy comprises a firmware update instruction.

14. The method of claim 13 wherein the device policy comprises a device configuration.

15. A method comprising:
retrieving a device list identifying a plurality of multifunction peripherals associated with a customer account;
identifying a network address of each of the identified multifunction peripherals;
retrieving historical update information corresponding to prior updates to the identified multifunction peripherals;
assigning one of a primary device designation or a secondary device designation to each of the identified multifunction peripherals in accordance with the identified network addresses and the historical update information;
sending a first update instruction to each of the plurality of multifunction peripherals designated as primary, the first update instruction including a first instruction to download and install an update from a designated server; and
sending a second update instruction to each of the plurality of multifunction peripherals designated as secondary, the second update instruction identifying one of the multifunction peripherals designated as primary as a download source and including a second instruction to download the update from the download source and install the update.

16. The method of claim 15 further comprising determining whether an update operation on each of the plurality of multifunction peripherals is successful and generating a corresponding message to the designated server.

17. The method of claim 16 further comprising:
receiving a new update instruction responsive to a message indicative of an unsuccessful update, the new update instruction including an instruction to download the update from an alternative download source.

18. The method of claim 17 wherein the alternative download source is comprised as a secondary server for multifunction peripherals designated as primary.

19. The method of claim 17 wherein the alternative download source is comprised of a secondary multifunction peripheral identified as primary.

20. The method of claim 19 wherein the alternative download source is comprised as a secondary server for multifunction peripherals designated as primary.
